(19) United States
(12) Patent Application Publication
(10) Pub. No.: US 2023/0005727 A1
(43) Pub. Date: Jan. 5, 2023

(54) Method of Mass Analysis - SWATH with Orthogonal Fragmentation Methodology

(71) Applicant: DH TECHNOLOGIES DEVELOPMENT PTE. LTD., Singapore (SG)

(72) Inventor: Yves Le Blanc, Newmarket (CA)

(21) Appl. No.: 17/755,597

(22) PCT Filed: Sep. 22, 2020
(86) PCT No.: PCT/IB2020/058825

§ 371 Date: May 3, 2022

Related U.S. Application Data
(60) Provisional application No. 62/935,211, filed on Nov. 14, 2019.

(51) Int. Cl. H01J 49/00

(52) U.S. Cl. CPC H01J 49/0045; H01J 49/0031; H01J 49/0036

(57) ABSTRACT

In a DIA method, a specified precursor ion m/z range of interest is divided into a set of two or more precursor ion mass selection windows. A tandem mass spectrometer is instructed to select, dissociate using a first dissociation technique, and mass analyze each precursor ion mass selection window of the set within a specified cycle time. Product ion intensity and m/z measurements are produced for each window of the set using the first dissociation technique. The tandem mass spectrometer is also instructed to select, dissociate using a second dissociation technique, and mass analyze each precursor ion mass selection window of the set within the same cycle time. Product ion intensity and m/z measurements are produced for each window of the set using the second dissociation technique. Product ion measurements from both the first and second dissociation techniques are used to identify or quantitate compounds of a sample.

### RELATED APPLICATIONS

This application claims the benefit of U.S. Provisional Patent Application Ser. No. 62/935,211, filed on Nov. 14, 2019, the content of which is incorporated by reference herein in its entirety.

### INTRODUCTION

The teachings herein relate to operating a tandem mass spectrometer in a data-independent acquisition (DIA) method in which two or more different fragmentation or dissociation techniques are applied during each cycle. More particularly, the teachings herein relate to systems and methods for measuring the product ions of the precursor ion mass selection windows produced from using two or more different dissociation methods within each cycle time of a DIA tandem mass spectrometry method.

The systems and methods disclosed herein can also be performed using an additional and preceding sample separation device such as, but not limited to, a liquid chromatography (LC) device, or a differential mobility separation (DMS), or ion mobility (IM). The systems and methods disclosed herein can also be performed in conjunction with a processor, controller, microcontroller, or computer system, such as the computer system of FIG. 1.

### Single Dissociation Technique in MS/MS Experiments

In conventional biologic characterization, a single dissociation or fragmentation technique may not provide enough information to identify analytes in mass spectrometry/mass spectrometry (MS/MS) experiments. MS/MS data is routinely used to identify and quantify species with a high level of selectivity. Relying on selective fragmentation to record the response of an analyte is at the base of multiple reaction monitoring (MRM) and DIA analysis.

DIA, for example, is used in conventional peptide analysis. In this analysis, alignment of y-ions signals (typically 3 or more) is used to determine that the appropriate peptide is detected and quantified. Alignment of all liquid chromatography (LC) peaks at a given retention time (RT) is also used to generate MS/MS data for identification and confirmation that the right compound is detected (MS/MS spectra generate). This approach works well if selective fragments are generated for the species of interest (peptide/metabolites). However, this approach can become problematic if species share many common fragment ions (e.g., glycol peptide forming glycan fragments) or if little or no useful fragment information can be obtained (e.g., disulfide-linked peptides). In other words, in an MS/MS experiment, the dissociation or fragmentation technique used may not provide enough information to distinguish the analyte product ions from many other common product ions present in the sample.

One solution recently proposed to address this problem is to trigger a second orthogonal dissociation or fragmentation technique when it appears that not enough distinguishing fragmentation information might be obtained. A second orthogonal technique is one that uses a different mechanism of dissociation or fragmentation known to produce different types of fragments than the first technique used. As described below, an information-dependent acquisition (IDA) or data-dependent acquisition (DDA) method can be used, for example, to trigger a second orthogonal technique.

In U.S. Provisional Patent Application No. 62/877,173 (hereinafter the “'173 application”), for example, which is incorporated herein in its entirety, electron-based dissociation (ExD) is triggered in an IDA method when alkali-metal adducts of a compound are detected. When collision-induced dissociation (CID) MS/MS is performed on equivalent alkali-metal adducts of the same compound, such as [M+Na]⁺ or [M+K]⁺, weak or no fragment ions are typically observed. This reduces the effectiveness of IDA and the amount of information generated in metabolomic applications.

Electron-based dissociation (ExD) techniques, however, are known to be able to dissociate alkali-metal adducts. As a result, the '173 application is directed to detect alkali-metal adducts and trigger an ExD technique for the detected alkali-metal adducts in an IDA method. In this IDA method, the ExD technique is the second dissociation technique used. This second ExD technique is orthogonal to the first CID technique.

In an IDA method, certain precursor ions can be dissociated using both of the two dissociation techniques or certain precursor ions can be dissociated using either one of the two dissociation techniques. IDA relies on real-time logic and requires a significant effort on the part of the user to set up the method before acquisition. In other words, IDA is a complex MS/MS acquisition method and it does not guarantee that required MSMS information will be collected for compounds of interest.

In addition, in an IDA method, additional or complementary information is only obtained for certain instances where it is predicted that this information might be available. For all other instances, this additional or complementary information is not obtained. As a result, if it is later found that there are precursor ions in other areas of the mass range that should be interrogated for additional or complementary product ion information, there is no other recourse than to conduct another experiment.

As a result, additional systems and methods are needed to be able to dissociate precursor ions using two or more different dissociation techniques in an MS/MS method other than IDA. These systems and methods are needed in order to provide enough information to distinguish analyte product ions from many other common product ions present in the sample.

### Fragmentation Techniques Background

Electron-based dissociation (ExD), ultraviolet photodissociation (UVPD), infrared photodissociation (IRMPD), and collision-induced dissociation (CID) are often used as fragmentation techniques for tandem mass spectrometry (MS/MS). CID is the most conventional technique for dissociation in tandem mass spectrometers.

ExD can include, but is not limited to, electron-induced dissociation (EID), electron impact excitation in organics (EIEIO), electron capture dissociation (ECD), or electron transfer dissociation (ETD).

### Background on Mass Spectrometry Techniques

Mass spectrometers are often coupled with chromatography or other separation systems in order to identify and characterize eluting known compounds of interest from a sample. In such a coupled system, the eluting solvent is ionized and a series of mass spectra are obtained from the eluting solvent at specified time intervals called retention times. These retention times range from, for example, 1 second to 100 minutes or greater. The series of mass spectra form a chromatogram, or extracted ion chromatogram (XIC).

Peaks found in the XIC are used to identify or characterize a known peptide or compound in the sample. More particularly, the retention times of peaks and/or the area of peaks are used to identify or characterize (quantify) a known peptide or compound in the sample.

In traditional separation coupled mass spectrometry systems, a fragment or product ion of a known compound is selected for analysis. A tandem mass spectrometry or mass spectrometry/mass spectrometry (MS/MS) scan is then performed at each interval of the separation for a mass range that includes the product ion. The intensity of the product ion found in each MS/MS scan is collected over time and analyzed as a collection of spectra, or an XIC, for example.

In general, tandem mass spectrometry, or MS/MS, is a well-known technique for analyzing compounds. Tandem mass spectrometry involves ionization of one or more compounds from a sample, selection of one or more precursor ions of the one or more compounds, fragmentation of the one or more precursor ions into fragment or product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. Three broad categories of these workflows are targeted acquisition, information-dependent acquisition (IDA) or data-dependent acquisition (DDA), and data-independent acquisition (DIA).

In a targeted acquisition method, one or more transitions of a precursor ion to a product ion are predefined for a compound of interest. As a sample is being introduced into the tandem mass spectrometer, the one or more transitions are interrogated or monitored during each time period or cycle of a plurality of time periods or cycles. In other words, the mass spectrometer selects and fragments the precursor ion of each transition and performs a targeted mass analysis only for the product ion of the transition. As a result, an intensity (a product ion intensity) is produced for each transition. Targeted acquisition methods include, but are not limited to, multiple reaction monitoring (MRM) and selected reaction monitoring (SRM).

In an IDA method, a user can specify criteria for performing an untargeted mass analysis of product ions, while a sample is being introduced into the tandem mass spectrometer. For example, in an IDA method, a precursor ion or mass spectrometry (MS) survey scan is performed to generate a precursor ion peak list. The user can select criteria to filter the peak list for a subset of the precursor ions on the peak list. MS/MS is then performed on each precursor ion of the subset of precursor ions. A product ion spectrum is produced for each precursor ion. MS/MS is repeatedly performed on the precursor ions of the subset of precursor ions as the sample is being introduced into the tandem mass spectrometer.

In proteomics and many other sample types, however, the complexity and dynamic range of compounds are very large. This poses challenges for traditional targeted and IDA methods, requiring very high-speed MS/MS acquisition to deeply interrogate the sample in order to both identify and quantify a broad range of analytes.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a traditional DIA method, the actions of the tandem mass spectrometer are not varied among MS/MS scans based on data acquired in a previous precursor or product ion scan. Instead, a precursor ion mass range is selected. A precursor ion mass selection window is then stepped across the precursor ion mass range. All precursor ions in the precursor ion mass selection window are fragmented and all of the product ions of all of the precursor ions in the precursor ion mass selection window are mass analyzed.

The precursor ion mass selection window used to scan the mass range can be very narrow so that the likelihood of multiple precursors within the window is small. This type of DIA method is called, for example, MS/MS^{ALL}. In an MS/MS^{ALL} method, a precursor ion mass selection window of about 1 amu is scanned or stepped across an entire mass range. A product ion spectrum is produced for each 1 amu precursor mass window. The time it takes to analyze or scan the entire mass range once is referred to as one scan cycle. Scanning a narrow precursor ion mass selection window across a wide precursor ion mass range during each cycle, however, is not practical for some instruments and experiments.

As a result, a larger precursor ion mass selection window, or selection window with a greater width, is stepped across the entire precursor mass range. This type of DIA method is called, for example, SWATH acquisition. In a SWATH acquisition, the precursor ion mass selection window stepped across the precursor mass range in each cycle may have a width of 5-25 amu, or even larger. Like the MS/MS' method, all the precursor ions in each precursor ion mass selection window are fragmented, and all of the product ions of all of the precursor ions in each mass selection window are mass analyzed.

U.S. Pat. No. 8,809,770, which is incorporated herein in its entirety, describes how SWATH acquisition can be used to provide quantitative and qualitative information about the precursor ions of compounds of interest. In particular, the product ions found from fragmenting a precursor ion mass selection window are compared to a database of known product ions of compounds of interest. In addition, ion traces or XICs of the product ions found from fragmenting a precursor ion mass selection window are analyzed to provide quantitative and qualitative information.

FIG. 2 is an exemplary diagram 200 of a precursor ion mass-to-charge ratio (m/z) range that is divided into ten precursor ion mass selection windows for a data independent acquisition (DIA) SWATH workflow. The m/z range shown in FIG. 2 is 200 m/z. Note that the terms “mass” and “m/z” are used interchangeably herein. Generally, mass spectrometry measurements are made in m/z and converted to mass by multiplying by charge.

Each of the ten precursor ion mass selection or isolation windows spans or has a width of 20 m/z. Three of the ten precursor ion mass selection windows, windows 201, 202, and 210, are shown in FIG. 2. Precursor ion mass selection windows 201, 202, and 210 are shown as non-overlapping windows with the same width. Precursor ion mass selection windows can also overlap and/or can have variable widths.

FIG. 2 depicts non-variable and non-overlapping precursor ion mass selection windows used in a single cycle of an exemplary SWATH acquisition. A tandem mass spectrometer that can perform a SWATH acquisition method can further be coupled with a sample introduction device that separates one or more compounds from the sample over time, for example. A sample introduction device can introduce a sample to the tandem mass spectrometer using a technique that includes, but is not limited to, injection, liquid chromatography, gas chromatography, or capillary electrophoresis. The separated one or more compounds are ionized by an ion source, producing an ion beam of precursor ions of the one or more compounds that are selected and fragmented by the tandem mass spectrometer.

As a result, for each time step of a sample introduction of separated compounds, each of the ten precursor ion mass selection windows is selected and then fragmented, producing ten product ion spectra for the entire m/z range. In other words, each of the ten precursor ion mass selection windows is selected and then fragmented during each cycle of a plurality of cycles.

FIG. 3 is an exemplary diagram 300 that graphically depicts the steps for obtaining product ion traces or XICs from each precursor ion mass selection window during each cycle of a DIA workflow. For example, ten precursor ion mass selection windows, represented by precursor ion mass selection windows 201, 202, and 210 in FIG. 3, are selected and fragmented during each cycle of a total of 1000 cycles.

During each cycle, a product ion spectrum is obtained for each precursor ion mass selection window. For example, product ion spectrum 311 is obtained by fragmenting precursor ion mass selection window 201 during cycle 1, product ion spectrum 312 is obtained by fragmenting precursor ion mass selection window 201 during cycle 2, and product ion spectrum 313 is obtained by fragmenting precursor ion mass selection window 201 during cycle 1000.

By plotting the intensities of the product ions in each product ion spectrum of each precursor ion mass selection window over time, XICs can be calculated for each product ion produced from each precursor ion mass selection window. For example, plot 320 includes the XICs calculated for each product ion of the 1000 product ion spectra of precursor ion mass selection window 201. Note that XICs can be plotted in terms of time or cycles.

The XICs in plot 320 are shown plotted in two dimensions in FIG. 3. However, each XIC is actually three-dimensional, because the different XICs are calculated for different m/z values.

FIG. 4 is an exemplary diagram 400 that shows the three-dimensionality of product ion XICs obtained for a precursor ion mass selection window over time. In FIG. 4, the x axis is time or cycle number, they axis is product ion intensity, and the z axis is m/z. From this three-dimensional plot, more information is obtained. For example, XIC peaks 410 and 420 both have the same shape and occur at the same time, or same retention time. However, XIC peaks 410 and 420 have different m/z values. This may mean that XIC peaks 410 and 420 are isotopic peaks or represent different product ions from the same precursor ion. Similarly, XIC peaks 430 and 440 have the same m/z value but occur at different times. This may mean that XIC peaks 430 and 440 are the same product ion, but they are from two different precursor ions.

FIGS. 2-4 show how mass and retention time can be used to characterize compounds such as peptides using a DIA method. However, as described above, this approach works well if selective fragments are generated for the species of interest. However, this approach can become problematic if species share many common fragment ions or if little or no useful fragment information can be obtained. As a result, additional systems and methods are needed to discriminate compounds or peptides with similar mass and minor differences in retention time behavior.

### Background on Cycle Time

The cycle time, scan time, or duty cycle time of a DIA experiment is the amount of time it takes to acquire all of the targeted MS/MS data for the entire mass range. Returning to FIG. 3, in a conventional DIA method, the cycle time is the amount of time it takes to acquire all of the MS/MS data for all ten precursor ion mass selection windows 201 to 210. In other words, the cycle time is the amount of time it takes to perform each cycle.

The cycle time is a user specified parameter for an experiment. The cycle time selected has implications for other times. For example, the dwell time may refer to the amount of time any of the ten precursor ion mass selection windows 201 to 210 in FIG. 3 is selected, dissociated, and mass analyzed. A longer cycle time allows for a longer dwell time, which, in turn, produces higher quality results for each precursor ion mass selection window.

However, the length of the cycle time is typically limited based on chromatographic considerations. Each cycle time provides a data point across an LC or XIC peak. As a result, shorter cycle times provide more points across an LC or XIC peak. Typically, for example, a cycle time that provides 10-15 data points across an LC or XIC peak is optimal for accurate quantitation and reproducibility. Consequently, the cycle time of each of the 1000 cycles in FIG. 3 is typical set to provide 10-15 data points across the peaks shown in plot 320.

### SUMMARY

A system, method, and computer program product are disclosed for performing at least two different dissociation techniques in each cycle of a DIA mass spectrometry experiment. The system includes an ion source device and a tandem mass spectrometer. The ion source device ionizes compounds of a sample, producing an ion beam. The tandem mass spectrometer includes a mass filter device, one or more dissociation devices that perform at least two different dissociation techniques, and a mass analyzer.

The tandem mass spectrometer receives the ion beam from the ion source device. The tandem mass spectrometer divides a specified precursor ion mass-to-charge ratio (m/z) range of the ion beam into a first set of two or more precursor ion mass selection windows. The tandem mass spectrometer also divides the precursor ion m/z range of the ion beam into a second set of two or more precursor ion mass selection windows.

Within a specified cycle time, the tandem mass spectrometer analyzes each precursor ion mass selection window of the first set. The tandem mass spectrometer selects each precursor ion mass selection window of the first set using the mass filter device. The tandem mass spectrometer dissociates each window of the first set using a first dissociation technique of the at least two different dissociation techniques performed by the one or more dissociation devices. The tandem mass spectrometer mass analyzes product ions generated from the dissociation of each window of the first set using the mass analyzer, producing product ion intensity and m/z measurements for each window of the first set.

Also, within the same cycle time, the tandem mass spectrometer selects each precursor ion mass selection window of the second set using the mass filter device. The tandem mass spectrometer dissociates each window of the second set using a second dissociation technique of the at least two different dissociation techniques performed by the one or more dissociation devices. The tandem mass spectrometer mass analyzes product ions generated from the dissociation of each window of the second set using the mass analyzer, producing product ion intensity and m/z measurements for each window of the second set.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary diagram of a precursor ion mass-to-charge ratio (m/z) range that is divided into ten precursor ion mass selection windows for a data independent acquisition (DIA) SWATH workflow.

FIG. 3 is an exemplary diagram that graphically depicts the steps for obtaining product ion traces or extracted ion chromatograms (XICs) from each precursor ion mass selection window during each cycle of a DIA workflow.

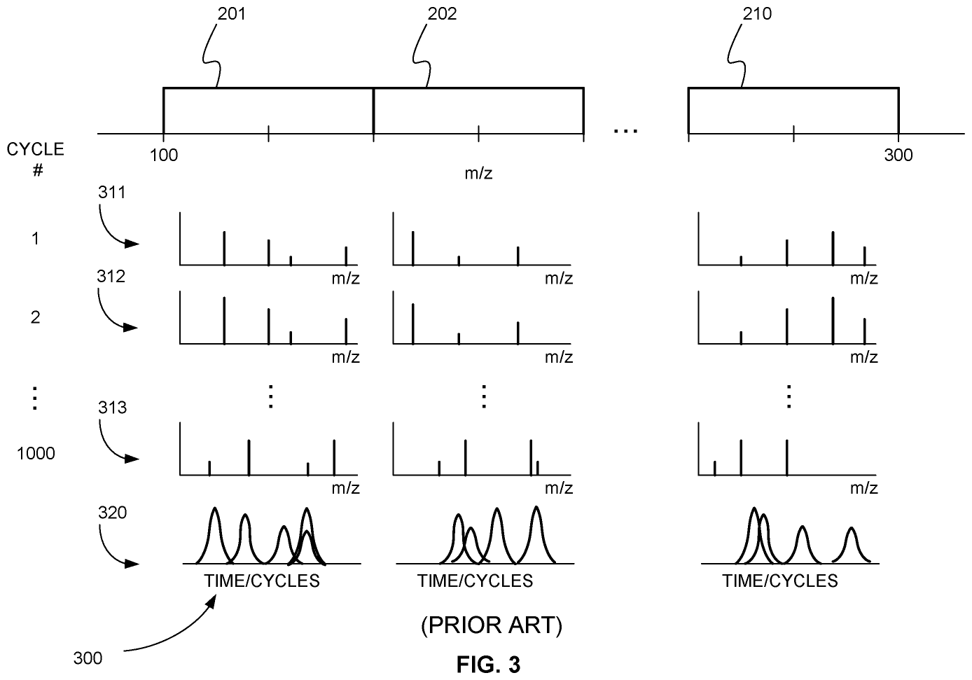

FIG. 4 is an exemplary diagram that shows the three-dimensionality of product ion XICs obtained for a precursor ion mass selection window over time.

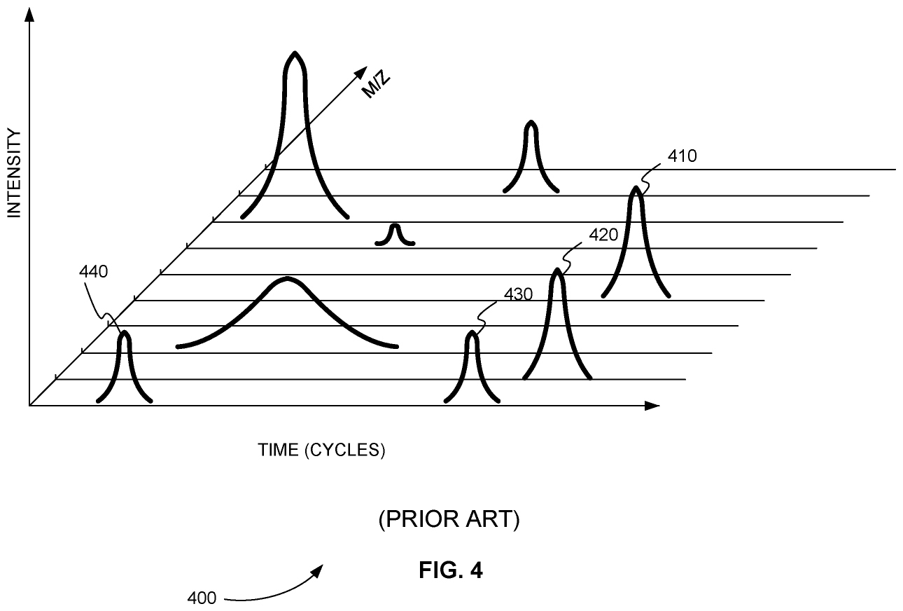

FIG. 5 is a cutaway three-dimensional perspective view of a Chimera electron capture dissociation (ECD) and collision-induced dissociation (CID) collision cell, in accordance with various embodiments.

FIG. 6 is an exemplary flowchart showing the steps performed in a single cycle of a DIA method in which each precursor ion mass selection window of a plurality of precursor ion mass selection windows is fragmented using each of two orthogonal dissociation techniques (CID and ECD), in accordance with various embodiments.

FIG. 7 is a schematic diagram of a system for performing at least two different dissociation techniques in each cycle of a DIA mass spectrometry experiment, in accordance with various embodiments.

FIG. 8 is an exemplary diagram that graphically depicts the steps for performing at least two different dissociation techniques in each cycle of a DIA mass spectrometry experiment, in accordance with various embodiments.

FIG. 9 is a flowchart showing a method for performing at least two different dissociation techniques in each cycle of a DIA mass spectrometry experiment, in accordance with various embodiments.

FIG. 10 is a schematic diagram of a system that includes one or more distinct software modules that performs a method for performing at least two different dissociation techniques in each cycle of a DIA mass spectrometry experiment, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

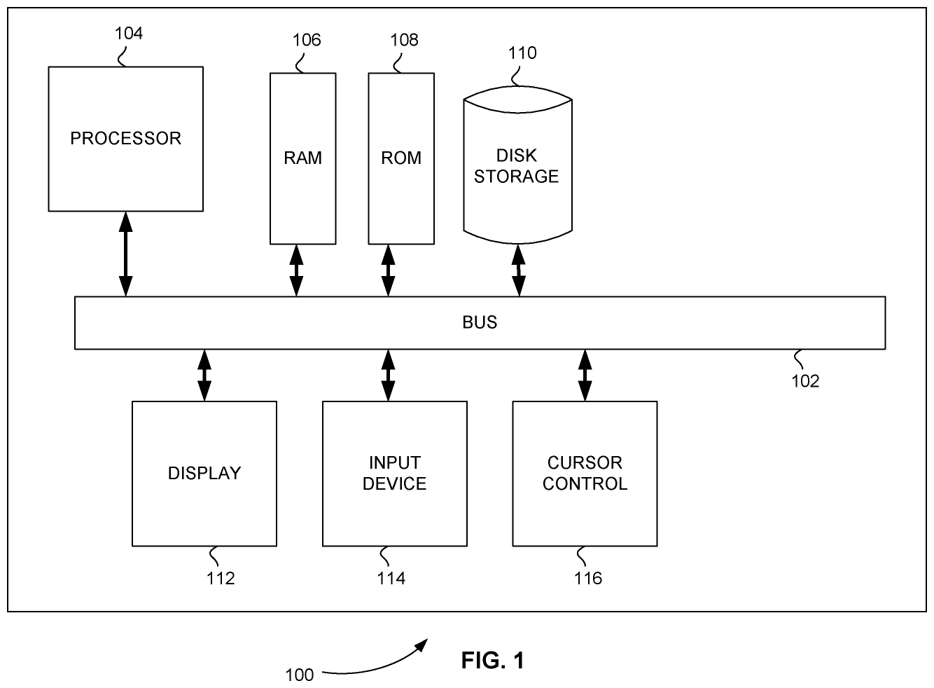

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Orthogonal Dissociation in DIA

As described above, a single dissociation or fragmentation technique may not provide enough information to identify analytes in mass spectrometry/mass spectrometry (MS/MS) experiments. The dissociation or fragmentation technique used may not provide enough information to distinguish analyte product ions from many other common product ions present in the sample.

One solution recently proposed to address this problem is to trigger a second orthogonal dissociation or fragmentation technique when it appears that not enough distinguishing fragmentation information might be obtained. An IDA or DDA method can be used, for example, to trigger a second orthogonal technique. However, IDA relies on real-time logic and requires a significant effort on the part of the user to set up the method before acquisition. In other words, IDA is a complex MS/MS acquisition method. In addition, in an IDA method, additional or complementary information is only obtained for certain instances where it is predicted that this information might be available.

As a result, additional systems and methods are needed to be able to dissociate precursor ions using two or more different dissociation techniques in an MS/MS method other than IDA. These systems and methods are needed in order to provide enough information to distinguish analyte product ions from many other common product ions present in the sample.

In various embodiments, a tandem mass spectrometer is modified to include one or more dissociation devices capable of performing at least two different or orthogonal dissociation techniques. The tandem mass spectrometer is then operated to perform a DIA method in which each precursor ion mass selection window of a plurality of precursor ion mass selection windows is fragmented using each of the at least two different or orthogonal dissociation techniques within the cycle time.

For example, SCIEX of Framingham, Mass. has developed a single dissociation device that can perform CID or ECD. This device is called a Chimera ECD and CID collision cell. A key to this collision cell is its multi-device interface. This multi-device interface is described in U.S. Pat. No. 7,358,488, which is incorporated herein in its entirety.

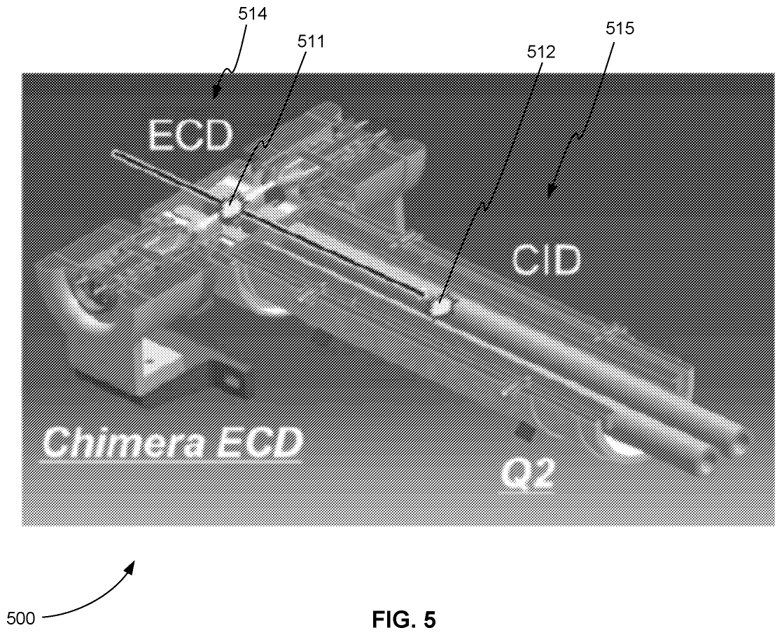

FIG. 5 is a cutaway three-dimensional perspective view 500 of a Chimera ECD and CID collision cell, in accordance with various embodiments. FIG. 5 shows that the dissociation of analyte ions can be performed selectively at location 511, in Chimera ECD multi-device interface 514 or at location 512 in CID collision cell 515. In this case, a single device, the Chimera ECD and CID collision cell, is capable of performing at least two different or orthogonal dissociation techniques. In various alternative embodiments, more than one dissociation device can be used.

A tandem mass spectrometer, including the Chimera ECD and CID collision, can then be operated to perform a DIA method in which each precursor ion mass selection window of a plurality of precursor ion mass selection windows is fragmented using each of the at least two different or orthogonal dissociation techniques within the cycle time. Ideally, the at least two different or orthogonal dissociation techniques generate complementary and unique product ions.

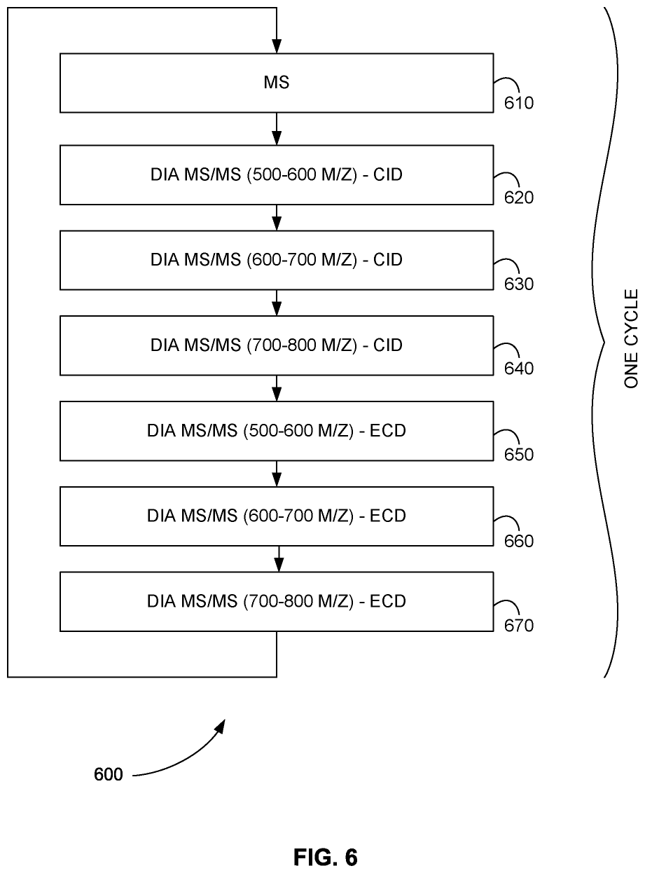

FIG. 6 is an exemplary flowchart 600 showing the steps performed in a single cycle of a DIA method in which each precursor ion mass selection window of a plurality of precursor ion mass selection windows is fragmented using each of two orthogonal dissociation techniques (CID and ECD), in accordance with various embodiments. In the DIA method of FIG. 6, the mass range of 500-800 m/z is analyzed. Within a specified cycle time, seven steps are performed. First, in step 610, the entire mass range of 500-800 m/z is selected and mass analyzed to determine the precursor ions in the mass range. In steps 620-640, precursor ion mass selection windows of 500-600, 600-700, and 700-800 m/z, respectively, are selected, the precursor ions within these windows are dissociated or fragmented using CID, and the resulting product ions are mass analyzed. In steps 650-670, precursor ion mass selection windows of 500-600, 600-700, and 700-800 m/z, respectively, are selected, the precursor ions within these windows are dissociated or fragmented using ECD, and the resulting product ions are mass analyzed.

In FIG. 6, the three precursor ion mass selection windows are all first dissociated using CID and then these three windows are all dissociated using ECD. In other words, the steps within the cycle time are ordered by dissociation technique.

In various alternative embodiments, the dissociation of one window using a first dissociation technique can immediately be followed by dissociation of the same window or another window using the second dissociation technique. For example, in FIG. 6, step 620 may be followed by step 650 instead of step 630. In other words, the steps within the cycle time can be ordered by precursor ion mass selection window range, for example.

In FIG. 6, the number of the precursor ion mass selection windows dissociated by CID and the range of each precursor ion mass selection windows dissociated by CID are the same as the number of the precursor ion mass selection windows dissociated by ECD and the range of each precursor ion mass selection windows dissociated by ECD. In other words, ECD is used to dissociate the same windows dissociated by CID.

In various alternative embodiments, the number of the precursor ion mass selection windows dissociated by CID can differ from the number of the precursor ion mass selection windows dissociated by ECD. Also, the range of each precursor ion mass selection windows dissociated by CID can differ from the range of each precursor ion mass selection windows dissociated by ECD. Also, the precursor ion mass window size can be different between CID and ECD. In other words, ECD can be used to dissociate different windows than CID. Both techniques, however, should still analyze the same overall precursor ion mass range. Note that using different precursor ion mass selection windows for different dissociation techniques makes comparing the data more difficult since product ions of differing precursor ion mass selection windows have to be compared, but could offer advantages in teasing out MSMS information.

Note that prior to the present embodiments described herein, it was not thought possible by those skilled in the art to perform two dissociation techniques across a useful mass range within a single cycle time using a DIA method. In other words, it was thought that there was not enough time to dissociate the precursor ion mass selection windows of a DIA method twice and still get enough data points across an LC peak.

In various embodiments, due to at least two recent improvements, it is now possible to dissociate the precursor ion mass selection windows of a DIA method twice and still get enough data points across an LC peak. First of all, dissociation devices that provide dissociation techniques other than CID have recently been significantly improved. For example, using the Chimera ECD and CID collision cell of SCIEX, a precursor ion mass selection window can now be selected, dissociated using ECD, and mass analyzed within 50 to 100 ms (or even less).

Secondly, using samples from which analytes can be well separated allows larger precursor ion mass selection windows to be used in a DIA method, which, in turn, requires fewer dissociation steps. For example, it has been found that since most biologic analyses originate from a simplified digest that can be well separated by LC, larger precursor ion mass selection windows (100-200 m/z wide) can be used. This allows a smaller number of precursor ion mass selection windows to be used, which means fewer dissociation steps within each cycle time. In other words, for certain samples, larger precursor ion mass selection windows can be used, which allows enough time to perform at least two different dissociation techniques on these windows.

This also opens up the possibility to interrogate data in the MS/MS mode to identify regions of interest using the first dissociation technique. Then, the identified region of interest is used to process the data from the second dissociation technique. For example, in the analysis of glycopeptides, an XIC calculated from the CID MS/MS of a specific glycan residue can be used to generate the location of glycopeptides. Then, an XIC calculated from the ECD MS/MS can be used to identify the specific glycopeptide fragments.

Performing at least two different or orthogonal dissociation techniques on the precursor ion mass selection windows in a DIA method provides a number of advantages over triggering a second orthogonal dissociation in an IDA method. For example, from a user perspective, the set up of a DIA method is much simpler than IDA method. In addition, as described above, in an IDA method, additional or complementary information is only obtained for certain instances where it is predicted that this information might be available. So, the complementary information is not available for the entire mass range.

In contrast, in a DIA method, the complementary information from both dissociation techniques is available for the entire mass range. As a result, if it is later found that there are precursor ions in other areas of the mass range that should be interrogated for additional or complementary product ion information, there is no need to conduct another experiment. The data already collected can be interrogated for this information.

### System for Orthogonal Dissociation in DIA

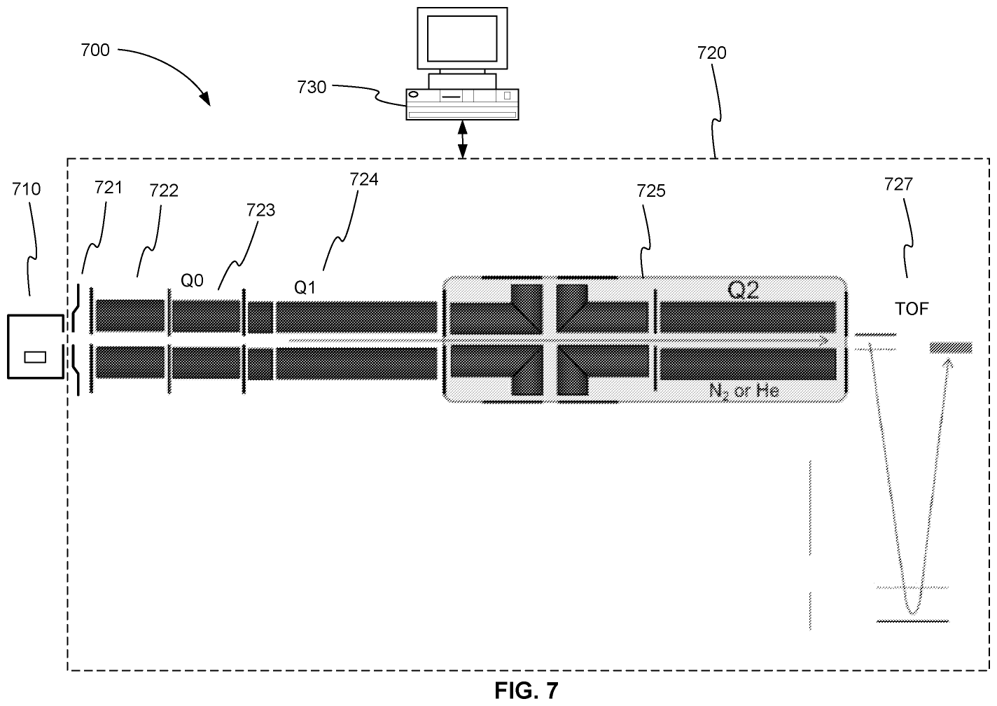

FIG. 7 is a schematic diagram of a system 700 for performing at least two different dissociation techniques in each cycle of a DIA mass spectrometry experiment, in accordance with various embodiments. The system of FIG. 7 includes ion source device 710 and tandem mass spectrometer 720.

Ion source device 710 ionizes compounds of a sample, producing an ion beam. Ion source device 710 can be, but is not limited to, an electrospray ion source (ESI) device, a chemical ionization (CI) source device such as an atmospheric pressure chemical ionization source (APCI) device, atmospheric pressure photoionization (APPI) source device, or a matrix-assisted laser desorption source (MALDI) device. In an exemplary embodiment, ion source device 710 is an ESI device.

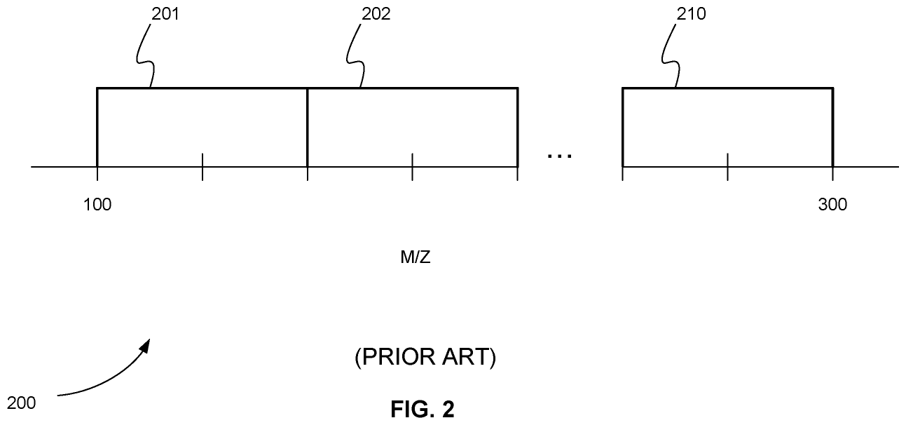

Tandem mass spectrometer 720 includes mass filter device 724, one or more dissociation devices 725 that perform at least two different dissociation techniques, and mass analyzer 727. Mass filter device 724, in the exemplary embodiment shown in FIG. 2, is a Q1 quadrupole. However, mass filter device 724 can be any type of mass filter, such as an ion trap.

One or more dissociation devices 725, in the exemplary embodiment shown in FIG. 7, is a Chimera ECD and CID collision cell, like the collision cell shown in FIG. 5. One or more dissociation devices 725 is, therefore, one physical device as shown in FIG. 7. However, in various alternative embodiments, one or more dissociation devices 725 can include two or more physical devices.

In various embodiments, the at least two different dissociation techniques performed by one or more dissociation devices 725 include one or more of electron-based dissociation (ExD), ultraviolet photodissociation (UVPD), infrared photodissociation (IRMPD), and collision-induced dissociation (CID).

Mass analyzer 727, in the exemplary embodiment shown in FIG. 7, is a time-of-flight (TOF) mass analyzer. However, mass analyzer 727 can be any type of mass analyzer including, but not limited to, a quadrupole, an ion trap, a linear ion trap, an orbitrap, or a Fourier transform ion cyclotron resonance mass analyzer.

Tandem mass spectrometer 720 receives the ion beam from ion source device 710. Tandem mass spectrometer 720 divides a specified precursor ion mass-to-charge ratio (m/z) range of the ion beam into a first set of two or more precursor ion mass selection windows. Tandem mass spectrometer 720 also divides the precursor ion m/z range of the ion beam into a second set of two or more precursor ion mass selection windows.

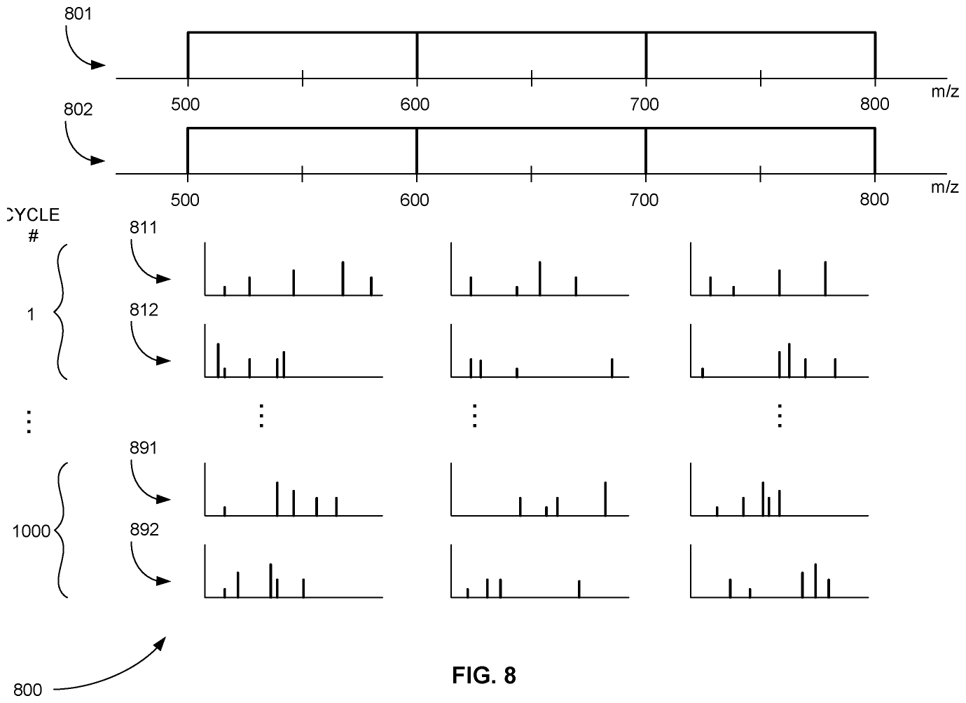

FIG. 8 is an exemplary diagram 800 that graphically depicts the steps for performing at least two different dissociation techniques in each cycle of a DIA mass spectrometry experiment, in accordance with various embodiments. In FIG. 8, a specified precursor ion mass-to-charge ratio (m/z) range (500-800 m/z) of the ion beam is divided into a first set 801 of three precursor ion mass selection windows. The same specified precursor ion m/z range is also divided into a second set 802 of three precursor ion mass selection windows.

The specified precursor ion m/z range is determined before acquisition for a particular experiment, for example. As described above, if a simplified digest is used, wider precursor ion mass selection windows than those used in traditional DIA methods can be used. This allows a smaller number of precursor ion mass selection windows to be used, which means fewer dissociation steps within each cycle time.

As shown in FIG. 8, first set 801 and second set 802 are actually the same set of three precursor ion mass selection windows. As a result, only one set of three precursor ion mass selection windows is actually used in this case.

In various alternative embodiments, first set 801 and second set 802 can have different numbers of precursor ion mass selection windows. For example, first set 801 can have three precursor ion mass selection windows, but second set 802 may have just two precursor ion mass selection windows (not shown) spanning precursor ion m/z range 500-800 m/z. Therefore, the first set and the second set have different numbers of precursor ion mass selection windows.

Also, if second set 802 has just two precursor ion mass selection windows and still spans precursor ion m/z range 500-800 m/z, then its windows have to be wider than the windows of first set 801. Therefore, in various embodiments not shown, windows of the first set can have different windows widths than windows of the second set.

Further, if second set 802 has just two precursor ion mass selection windows and still spans precursor ion m/z range 500-800 m/z, then its windows have to have different m/z ranges than the windows of first set 801. Therefore, in various embodiments not shown, windows of the first set can have different m/z ranges than windows of the second set.

Returning to FIG. 7, within a specified cycle time, tandem mass spectrometer 720 analyzes each precursor ion mass selection window of the first set. For example, tandem mass spectrometer 720 selects each precursor ion mass selection window of the first set using mass filter device 724. Tandem mass spectrometer 720 dissociates each window of the first set using a first dissociation technique of the at least two different dissociation techniques using one or more dissociation devices 725. Tandem mass spectrometer 720 mass analyzes product ions generated from the dissociation of each window of the first set using mass analyzer 727, producing product ion intensity and m/z measurements for each window of the first set.

Also, within the same cycle time, tandem mass spectrometer 720 selects each precursor ion mass selection window of the second set using mass filter device 724. Tandem mass spectrometer 720 dissociates each window of the second set using a second dissociation technique of the at least two different dissociation techniques using one or more dissociation devices 725. Tandem mass spectrometer 720 mass analyzes product ions generated from the dissociation of each window of the second set using mass analyzer 727, producing product ion intensity and m/z measurements for each window of the second set.

The cycle time is, for example, specified by a user and entered before acquisition. As described above, the length of the cycle time is typically limited based on chromatographic considerations. Each cycle provides a data point across an LC or XIC peak. As a result, shorter cycle times provide more points across an LC or XIC peak.

Returning to FIG. 8, within the same cycle time or cycle, each precursor ion mass selection window of first set 801 is selected, dissociated using a first dissociation technique, and mass analyzed, producing product ion intensity and m/z measurements for each window of first set 801. For example, in cycle 1, product ion intensity and m/z measurements 811 are produced for each window of first set 801. In addition, within the same cycle time or cycle, each precursor ion mass selection window of second set 802 is selected, dissociated using a second dissociation technique, and mass analyzed, producing product ion intensity and m/z measurements for each window of second set 802. In cycle 1, therefore, product ion intensity and m/z measurements 812 are also produced for each window of second set 802.

FIG. 8 shows that a total of 1000 cycles are performed. In each cycle, each precursor ion mass selection window of first set 801 is selected, dissociated using the first dissociation technique, and mass analyzed, producing product ion intensity and m/z measurements for each window of first set 801. In addition, within each cycle, each precursor ion mass selection window of second set 802 is selected, dissociated using the second dissociation technique, and mass analyzed, producing product ion intensity and m/z measurements for each window of second set 802. For example, in cycle 1000, product ion intensity and m/z measurements 891 are produced for each window of first set 801, and product ion intensity and m/z measurements 892 are produced for each window of second set 802.

The measurements across the 1000 cycles of FIG. 8 can be used to plot XIC peaks (not shown) for the product ions measured. In various embodiments, the product ion intensity and m/z measurements for each window of first set 801 are analyzed separately from the product ion intensity and m/z measurements for each window of second set 802 in order to identify or quantitate the compounds of the sample. In other words, product ions produced from the two different dissociation techniques are analyzed separately or independently.

In various alternative embodiments, the product ion intensity and m/z measurements for each window of first set 801 are combined with the product ion intensity and m/z measurements for each window of second set 802 and the combined measurements are analyzed to identify or quantitate the compounds of the sample. In other words, product ions produced from the two different dissociation techniques are analyzed from combined measurements.

Returning to FIG. 7, tandem mass spectrometer 720 can also perform an MS scan of the precursor ion m/z range. Tandem mass spectrometer 720 further, within the same cycle time, selects the precursor ion m/z range using mass filter device 724, transmits precursor ions of the precursor ion m/z range from mass filter device 724 to mass analyzer 727 using one or more dissociation devices 725, and mass analyzes the transmitted precursor ions using mass analyzer 727, producing precursor ion intensity and m/z measurements for the precursor ion m/z range. Precursor ion intensity and m/z measurements are used to match product ion measurements to particular precursor ions. For example, as described above, product ions are matched to precursor ions using retention times.

Returning to FIG. 6, typically one MS scan is performed within each cycle to obtain precursor ion intensity and m/z measurements for the precursor ion m/z range. FIG. 6 also shows that each window of the first set (using CID dissociation) is selected, dissociated, and mass analyzed before each window of the second set (using ECD) is selected, dissociated, and mass analyzed. In various alternative embodiments not shown, at least one window (e.g., the window of step 650) of the second set (using ECD) can be selected, dissociated, and mass analyzed after a first window (e.g., the window of step 620) of the first set (using CID dissociation) is selected, dissociated, and mass analyzed and before a second window (e.g., the window of step 630) of the first set (using CID dissociation) is selected, dissociated, and mass analyzed.

Returning to FIG. 7, in various embodiments, one or more dissociation devices 725 include just one dissociation device, and the one dissociation device performs the first dissociation technique and the second dissociation technique. In various embodiments not shown, one or more dissociation devices 724 include a first dissociation device and a second dissociation device, and the first dissociation device performs the first dissociation technique and the second dissociation device performs the second dissociation technique.

In various embodiments, processor 730 is used to control or provide instructions to ion source device 710, tandem mass spectrometer 720, mass filter device 724, one or more dissociation devices 725, and mass analyzer 727 and to analyze data collected. Processor 730 controls or provides instructions by, for example, controlling one or more voltage, current, or pressure sources (not shown). Processor 730 can be a separate device as shown in FIG. 7 or can be a processor or controller of one or more devices of tandem mass spectrometer 720. Processor 730 can be, but is not limited to, a controller, a computer, a microprocessor, the computer system of FIG. 1, or any device capable of sending and receiving control signals and data.

In various embodiments, tandem mass spectrometer 720 can further include orifice and skimmer 721, ion guide 722, and Q0 ion guide 723.

### Method for Orthogonal Dissociation in DIA

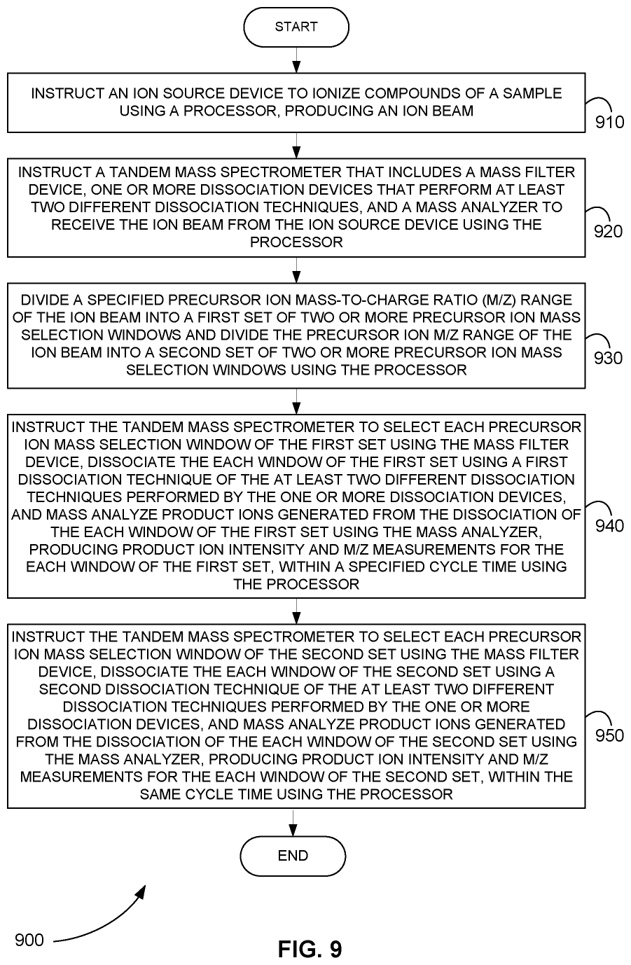

FIG. 9 is a flowchart showing a method 900 for performing at least two different dissociation techniques in each cycle of a DIA mass spectrometry experiment, in accordance with various embodiments.

In step 910 of method 900, an ion source device is instructed to ionize compounds of a sample using a processor. An ion beam is produced.

In step 920, a tandem mass spectrometer that includes a mass filter device, one or more dissociation devices that perform at least two different dissociation techniques, and a mass analyzer is instructed to receive the ion beam from the ion source device using the processor.

In step 930, a specified precursor ion m/z range of the ion beam is divided into a first set of two or more precursor ion mass selection windows using the processor. The precursor ion m/z range of the ion beam is also divided into a second set of two or more precursor ion mass selection windows using the processor.

In step 940, the tandem mass spectrometer is instructed to analyze each precursor ion mass selection window of the first set within a specified cycle time using the processor. The tandem mass spectrometer is instructed to select each precursor ion mass selection window of the first set using the mass filter device. The tandem mass spectrometer is instructed to dissociate each window of the first set using a first dissociation technique of the at least two different dissociation techniques performed by the one or more dissociation devices. The tandem mass spectrometer is instructed to mass analyze product ions generated from the dissociation of each window of the first set using the mass analyzer. Product ion intensity and m/z measurements are produced for each window of the first set.

In step 950, the tandem mass spectrometer is instructed to analyze each precursor ion mass selection window of the second set within the same cycle time using the processor. The tandem mass spectrometer is instructed to select each precursor ion mass selection window of the second set using the mass filter device. The tandem mass spectrometer is instructed to dissociate each window of the second set using a second dissociation technique of the at least two different dissociation techniques performed by the one or more dissociation devices. The tandem mass spectrometer is instructed to mass analyze product ions generated from the dissociation of each window of the second set using the mass analyzer within the same cycle time and using the processor. Product ion intensity and m/z measurements for each window of the second set.

### Computer Program Product for Orthogonal Dissociation in DIA

In various embodiments, computer program products include a tangible computer-readable storage medium whose contents include a program with instructions being executed on a processor so as to perform a method for performing at least two different dissociation techniques in each cycle of a DIA mass spectrometry experiment. This method is performed by a system that includes one or more distinct software modules.

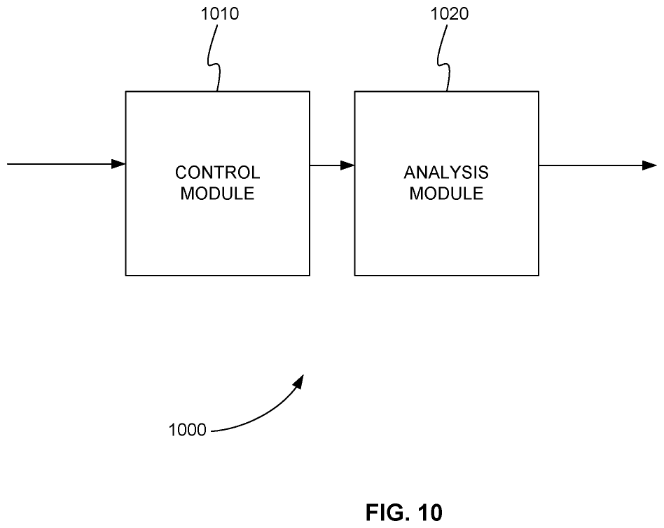

FIG. 10 is a schematic diagram of a system 1000 that includes one or more distinct software modules that performs a method for performing at least two different dissociation techniques in each cycle of a DIA mass spectrometry experiment, in accordance with various embodiments. System 1000 includes control module 1010 and analysis module 1020.

Control module 1010 instructs an ion source device to ionize compounds of a sample, producing an ion beam. Control module 1010 instructs a tandem mass spectrometer that includes a mass filter device, one or more dissociation devices that perform at least two different dissociation techniques, and a mass analyzer to receive the ion beam from the ion source device.

Analysis module 1020 divides a specified precursor ion m/z range of the ion beam into a first set of two or more precursor ion mass selection windows. Analysis module 1020 divides the precursor ion m/z range of the ion beam into a second set of two or more precursor ion mass selection windows.

Control module 1010 instructs the tandem mass spectrometer to analyze each precursor ion mass selection window of the first set within a specified cycle time. The tandem mass spectrometer is instructed to select each precursor ion mass selection window of the first set using the mass filter device. The tandem mass spectrometer is instructed to dissociate each window of the first set using a first dissociation technique of the at least two different dissociation techniques performed by the one or more dissociation devices. The tandem mass spectrometer is instructed to mass analyze product ions generated from the dissociation of each window of the first set using the mass analyzer. Product ion intensity and m/z measurements are produced for each window of the first set.

Control module 1010 instructs the tandem mass spectrometer to analyze each precursor ion mass selection window of the second set within the same cycle time. The tandem mass spectrometer is instructed to select each precursor ion mass selection window of the second set using the mass filter device. The tandem mass spectrometer is instructed to dissociate each window of the second set using a second dissociation technique of the at least two different dissociation techniques performed by the one or more dissociation devices. The tandem mass spectrometer is instructed to mass analyze product ions generated from the dissociation of each window of the second set using the mass analyzer within the same cycle time. Product ion intensity and m/z measurements are produced for each window of the second set.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for performing at least two different dissociation techniques in a data-independent acquisition (DIA) mass spectrometry experiment, comprising:
an ion source device that ionizes compounds of a sample, producing an ion beam; and
a tandem mass spectrometer that includes a mass filter device, one or more dissociation devices that perform at least two different dissociation techniques, and a mass analyzer, that receives the ion beam from the ion source device, and that
divides a specified precursor ion mass-to-charge ratio (m/z) range of the ion beam into a first set of two or more precursor ion mass selection windows and divides the precursor ion m/z range of the ion beam into a second set of two or more precursor ion mass selection windows,
within a specified cycle time, selects each precursor ion mass selection window of the first set using the mass filter device, dissociates the each window of the first set using a first dissociation technique of the at least two different dissociation techniques performed by the one or more dissociation devices, and mass analyzes product ions generated from the dissociation of the each window of the first set using the mass analyzer, producing product ion intensity and m/z measurements for the each window of the first set, and
within the cycle time, selects each precursor ion mass selection window of the second set using the mass filter device, dissociates the each window of the second set using a second dissociation technique of the at least two different dissociation techniques performed by the one or more dissociation devices, and mass analyzes product ions generated from the dissociation of the each window of the second set using the mass analyzer, producing product ion intensity and m/z measurements for the each window of the second set.

2. The system of claim 1, wherein the tandem mass spectrometer further, within the cycle time, selects the precursor ion m/z range using the mass filter device, transmits precursor ions of the precursor ion m/z range from the mass filter device to the mass analyzer using the one or more dissociation devices, and mass analyzes the transmitted precursor ions using the mass analyzer, producing precursor ion intensity and m/z measurements for the precursor ion m/z range.

3. The system of claim 1, wherein the first set and the second set are the same set.

4. The system of claim 1, wherein the first set and the second set have different numbers of precursor ion mass selection windows.

5. The system of claim 1, wherein windows of the first set have different windows widths than windows of the second set.

6. The system of claim 1, wherein windows of the first set have different m/z ranges than windows of the second set.

7. The system of claim 1, wherein each window of the first set is selected, dissociated, and mass analyzed before each window of the second set is selected, dissociated, and mass analyzed.

8. The system of claim 1, wherein at least one window of the second set is selected, dissociated, and mass analyzed after a first window of the first set is selected, dissociated, and mass analyzed and before a second window of the first set is selected, dissociated, and mass analyzed.

9. The system of claim 1, wherein the at least two different dissociation techniques include one or more of electron-based dissociation (ExD), ultraviolet photodissociation (UVPD), infrared photodissociation (IRMPD), and collision-induced dissociation (CID).

10. The system of claim 1, wherein the one or more dissociation devices comprise one dissociation device and the one dissociation device performs the first dissociation technique and the second dissociation technique.

11. The system of claim 1, wherein the one or more dissociation devices comprise a first dissociation device and a second dissociation device and the first dissociation device performs the first dissociation technique and the second dissociation device performs the second dissociation technique.

12. The system of claim 1, wherein the product ion intensity and m/z measurements for the each window of the first set are analyzed separately from the product ion intensity and m/z measurements for the each window of the second set in order to identify or quantitate the compounds of the sample.

13. The system of claim 1, wherein the product ion intensity and m/z measurements for the each window of the first set are combined with the product ion intensity and m/z measurements for the each window of the second set and the combined measurements are analyzed to identify or quantitate the compounds of the sample.

14. A method for performing at least two different dissociation techniques in a data-independent acquisition (DIA) mass spectrometry experiment, comprising:
instructing an ion source device to ionize compounds of a sample using a processor, producing an ion beam;
instructing a tandem mass spectrometer that includes a mass filter device, one or more dissociation devices that perform at least two different dissociation techniques, and a mass analyzer to receive the ion beam from the ion source device using the processor;
dividing a specified precursor ion mass-to-charge ratio (m/z) range of the ion beam into a first set of two or more precursor ion mass selection windows and dividing the precursor ion m/z range of the ion beam into a second set of two or more precursor ion mass selection windows using the processor;
instructing the tandem mass spectrometer to select each precursor ion mass selection window of the first set using the mass filter device, dissociate the each window of the first set using a first dissociation technique of the at least two different dissociation techniques performed by the one or more dissociation devices, and mass analyze product ions generated from the dissociation of the each window of the first set using the mass analyzer, producing product ion intensity and m/z measurements for the each window of the first set, within a specified cycle time using the processor; and
instructing the tandem mass spectrometer to select each precursor ion mass selection window of the second set using the mass filter device, dissociate the each window of the second set using a second dissociation technique of the at least two different dissociation techniques performed by the one or more dissociation devices, and mass analyze product ions generated from the dissociation of the each window of the second set using the mass analyzer, producing product ion intensity and m/z measurements for the each window of the second set, within the cycle time using the processor.

15. A computer program product, comprising a non-transitory and tangible computer-readable storage medium whose contents include a program with instructions being executed on a processor so as to perform a method for performing at least two different dissociation techniques in a data-independent acquisition (DIA) mass spectrometry experiment, the method comprising:
providing a system, wherein the system comprises one or more distinct software modules, and wherein the distinct software modules comprise a control module and an analysis module;
instructing an ion source device to ionize compounds of a sample using the control module, producing an ion beam;
instructing a tandem mass spectrometer that includes a mass filter device, one or more dissociation devices that perform at least two different dissociation techniques, and a mass analyzer to receive the ion beam from the ion source device using the control module;
dividing a specified precursor ion mass-to-charge ratio (m/z) range of the ion beam into a first set of two or more precursor ion mass selection windows and dividing the precursor ion m/z range of the ion beam into a second set of two or more precursor ion mass selection windows using the analysis module;
instructing the tandem mass spectrometer to select each precursor ion mass selection window of the first set using the mass filter device, dissociate the each window of the first set using a first dissociation technique of the at least two different dissociation techniques performed by the one or more dissociation devices, and mass analyze product ions generated from the dissociation of the each window of the first set using the mass analyzer, producing product ion intensity and m/z measurements for the each window of the first set, within a specified cycle time using the control module; and
instructing the tandem mass spectrometer to select each precursor ion mass selection window of the second set using the mass filter device, dissociate the each window of the second set using a second dissociation technique of the at least two different dissociation techniques performed by the one or more dissociation devices, and mass analyze product ions generated from the dissociation of the each window of the second set using the mass analyzer, producing product ion intensity and m/z measurements for the each window of the second set, within the cycle time using the control module.
